(19) United States
(12) Patent Application Publication
(10) Pub. No.: US 2006/0042137 A1
(43) Pub. Date: Mar. 2, 2006

(54) Method of creating miniature electrical glowing signs and sculptures

(76) Inventors: Andrew Thomas Bevilacqua, Huntville, AL (US); JoAnn Cynthia Bevilacqua, Huntville, AL (US)

Correspondence Address: ANDREW T. BEVILACQUA, 110 HOLBROOK DR., HUNTSVILLE, AL, 35806, US

(21) Appl. No.: 10/931,688

(22) Filed: Sep. 2, 2004

(51) Int. Cl. G09F 13/26

(52) U.S. Cl. 40/545

(57) ABSTRACT

A description of the method used to create miniature replicas of neon signs and sculptures. Electroluminescent (EL) wire is bent into shapes to replicate letters, numerals, arcs, polygons and other shapes as necessary to replicate actual articles at larger scales. Different colors of EL wire are used as necessary and soldered together at the ends to create multicolor signs and sculptures. A suitable alternating current power source is applied to the wire to cause it to glow or sparkle. When gaps are required in the glowing wire to replicate neon signs or to create artistic effects, dark opaque paint or other suitable material is used to coat the outer surface of the wire, therefore muting the glow in those areas.

### RELATED APPLICATIONS

The present application is related to U.S. Pat. No. 4,950,509, issued Aug. 21, 1990, for MINIATURE TREE SCULPTURE, by DeMott; Donald T., included by reference herein.

The present application is related to United States patent number 20040058615, issued Mar. 25, 2004, for ELECTROLUMINESCENT SIGN, by Murasko, Matthel; et al., included by reference herein.

The present application is related to United States patent number 20040047142, issued Mar. 11, 2004, for LIGHTED ARCHITECTURAL MESH, by Goslee, Daniel Lee, included by reference herein.

The present application is related to U.S. Pat. No. 5,229,149, issued Jul. 20, 1993, for STRAWBERRY SIMULATING A ROSE BUD, by Cone, Shari L., included by reference herein.

### FIELD OF THE INVENTION

The present invention relates to miniature sculptures and methods of fabricating such sculptures and, more particularly, the present invention relates to making miniature sculptures using electrolunimescent wire, bent into shapes and letters to represent any type of glowing electrical neon or gas tube sign or sculpture in small scale.

### BACKGROUND OF THE INVENTION

Miniature representations of real-world articles require that the object present a realistic looking replica in a desired scale. Because of the small diameter required at scales below 6″=1 Foot scale, real neon gas-filled tubes cannot operate effectively because small diameter glass tubes are extremely brittle and the electrical properties of voltage and current required to produce a glow in such a small neon-filled cavity is impractical.

The present invention seeks to provide a method of simulating neon and other linear glowing lights at small scales for hobby, craft, advertising, and other applications where actual neon gas-filled tubes are impractical or impossible because of the small sizes involved.

The invention teaches a realistic method of simulating working neon gas lights at small scales using small diameter electroluminescent wire.

Typically small diameter wire or flexible tubing is painted in fluorescent colors to represent neon lights or individual miniature peanut lights strung in tight rows are used to represent continuous lighting.

Painted wire, even if painted with fluorescent paint does not present an electrical glow like real neon and individual strung lights show breaks in between the individual lights no matter how closely they are packed. In addition, there are no individual lights small enough to represent continuous lighting in small scales below 6″−1 foot scale.

It is therefore an object of the invention to provide a means of replicating neon signs at small scales where actual neon-filled glass tubes are impractical, either because of the current and voltage necessary, because of the brittleness of small diameter glass tubing, or other technical reasons relating to the manufacture of neon signs and sculptures at small scales.

It is another object of the invention to teach a method of simulating neon signs for applications where small scale is necessary such as in hobby, craft, advertising, photography and other applications.

### SUMMARY OF THE INVENTION

In accordance with the present invention, there is provided a description of the method used to create miniature replicas of neon signs and sculptures. Further the miniature replicas light up or glow when an alternating current of sufficient value is applied. Electroluminescent (EL) wire is bent into shapes to replicate letters, numerals, arcs, polygons and other shapes as necessary to replicate actual articles at larger scales. A suitable alternating current power source is applied to the wire to cause it to glow or sparkle.

It was discovered that when gaps are required in the glowing wire to replicate neon signs or to create artistic effects, dark opaque paint or other suitable material can be used to coat the outer surface of the wire, therefore muting the glow in those areas.

It was further discovered, as a feature of the present invention, that coating the outer surfaces of the wire with a clear protective layer resulted in increased stiffness and durability of the sculpture without reducing the glow from the electrical stimulation of the wire. This allows the wire to be mounted to other structures to simulate real neon signs in small scales.

As another feature of the present invention, it was discovered that using heat shrinkable tubing over soldered connections in the sculpture could be used to simulate the effect of the actual glass-to-wire electrical cathodes in common use in full-scale neon signs. This feature also facilitates the fabrication of multicolor replicas whereas different colors of electroluminescent wire can be soldered together to form multicolored replicas.

The above described and many other features and attendant advantages of the present invention will become better understood by reference to the following detailed description when taken in conjunction with the accompanying drawings.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front view of an electroluminescent cable or electroluminescent rope, bent into shapes to simulate glass neon-filled tubes at small scales;

FIG. 2 is a front view of a miniature neon sign showing how opaque coatings can be applied (represented with dotted lines in the figure) to give the impression of distinct letters in a continuous electroluminescent wire or wires from point A to point B;

FIG. 3 is a front view of a pieces of different color electroluminescent wire soldered together to form joints such that multicolor replicas of signs and sculptures can be created; and

FIG. 4 is a front view of a solder joint between a large diameter electroluminescent wire and a smaller diameter electroluminescent wire showing how joints between neon glass tubes and wires can be replicated at small scales.

For purposes of clarity and brevity, like elements and components will bear the same designations and numbering throughout the FIGURES.

### DESCRIPTION OF THE PREFERRED EMBODIMENT

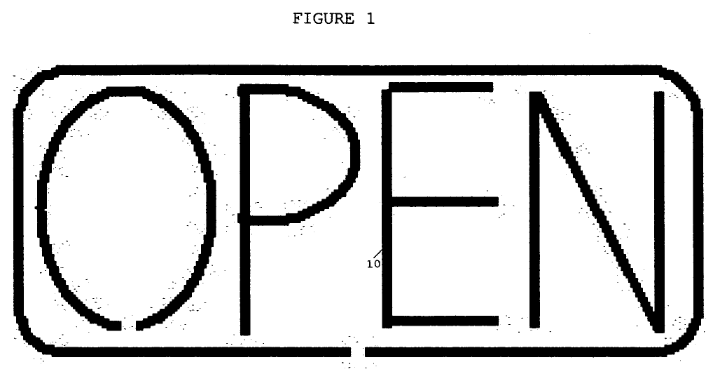

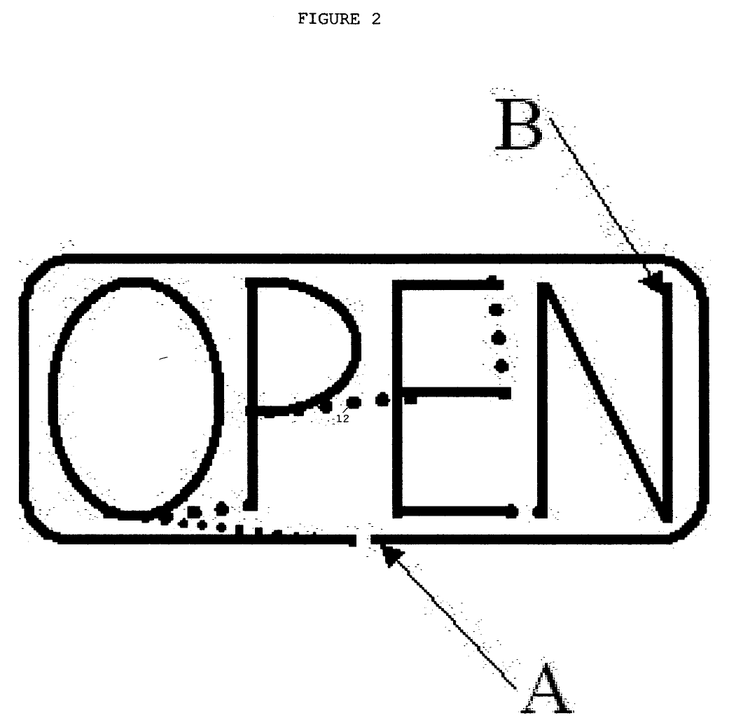

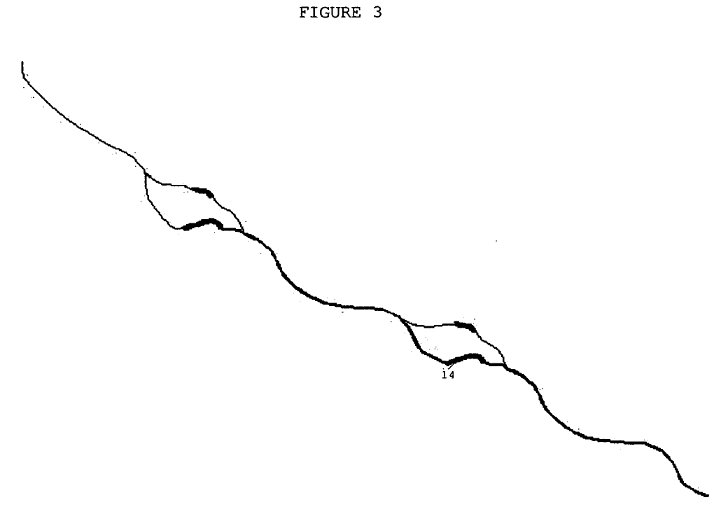

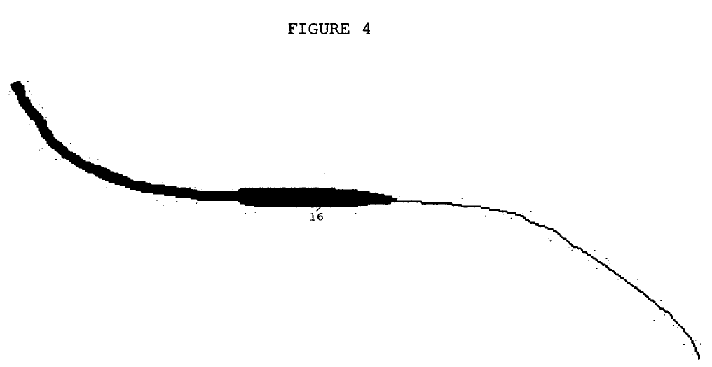

Referring to FIG. 1, the invention makes use of one or more pieces of small diameter electroluminescent (EL) wire also referred to as an electroluminescent cable or electroluminescent rope, bent into shapes to simulate glass neon-filled tubes at small scales as shown in the specific embodiment of an “OPEN” Neon sign representation 10. Referring to FIG. 2, dark paint or other forms of coating 12 are used at various locations to cover up the glow from the wire and create the impression of gaps in the sculpture or sign. Referring to FIG. 3, when different colors are needed to create connection 14, the electroluminescent wire is soldered together at the proper locations. Referring to FIG. 4, a Joining with opaque coating 16 between large diameter and smaller diameter electroluminescent wires can be covered with coating 12 to represent a connection 14 between a neon tube and an electrical wire such as is found in real neon signs at large scale. A suitable power source is used to cause the EL wire to glow giving the impression of a neon light. EL wire generally comprises a core wire coated with a phosper and wrapped with thin wires to create a capacitance effect that causes the phosphor to glow when alternating current of a suitable frequency is applied. This capacitive element is then coated with a waterproof sealer such as plastic or PVC. Electroluminescent wire of this type can be acquired from Shenzhen SMD Electronic Co. Ltd., 1st building, 2nd Industrial Village, Ma' bu New Village, Xi'xiang Town, Bao'an District Shenzhen, Guangdong Province, P.R.China.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method of creating miniature electrical glowing signs and sculptures for providing realistic working representations of neon signs or sculptures in small scales comprising:
means for creating the impression of distinct letters in a miniature sign or sculpture;
means for showing how wires of different colors can be soldered together to create multicolor signs;
means for showing how a solder joint between a large diameter and smaller diameter wire can be used to represent the joints between neon glass tubes and cathodes in real neon sign of larger scale; and
means for showing how small diameter electroluminescent wire can be bent into shapes such as letters, numerals, arcs and polygons to replicate small scale neon signs and sculptures.

2. The method of creating miniature electrical glowing signs and sculptures in accordance with claim 1, wherein said means for creating the impression of distinct letters in a miniature sign or sculpture comprises an opaque coating.

3. The method of creating miniature electrical glowing signs and sculptures in accordance with claim 1, wherein said means for showing how wires of different colors can be soldered together to create multicolor signs comprises a soldered connection.

4. The method of creating miniature electrical glowing signs and sculptures in accordance with claim 1, wherein said means for showing how a solder joint between a large diameter and smaller diameter wire can be used to represent the joints between neon glass tubes and cathodes in real neon sign of larger scale comprises a solder joining with opaque coating.

5. The method of creating miniature electrical glowing signs and sculptures in accordance with claim 1, wherein said means for showing how small diameter electroluminescent wire can be bent into shapes such as letters, numerals, arcs and polygons to replicate small scale neon signs and sculptures comprises a bent Electroluminescent wire neon sign representation.

6. A method of creating miniature electrical glowing signs and sculptures for providing realistic working representations of neon signs or sculptures in small scales comprising:
an opaque coating, for creating the impression of distinct letters in a miniature sign or sculpture;
a soldered connection, for showing how wires of different colors can be soldered together to create multicolor signs;
a solder joining with opaque coating, for showing how a solder joint between a large diameter and smaller diameter wire can be used to represent the joints between neon glass tubes and cathodes in real neon sign of larger scale; and
a bent Electroluminescent wire neon sign representation, for showing how small diameter electroluminescent wire can be bent into shapes such as letters, numerals, arcs and polygons to replicate small scale neon signs and sculptures.

7. A method of creating miniature electrical glowing signs and sculptures for providing realistic working representations of neon signs or sculptures in small scales comprising:
an opaque coating, for creating the impression of distinct letters in a miniature sign or sculpture;
a soldered connection, for showing how wires of different colors can be soldered together to create multicolor signs;
a solder joining with opaque coating, for showing how a solder joint between a large diameter and smaller diameter wire can be used to represent the joints between neon glass tubes and cathodes in real neon sign of larger scale; and
a bent Electroluminescent wire neon sign representation, for showing how small diameter electroluminescent wire can be bent into shapes such as letters, numerals, arcs and polygons to replicate small scale neon signs and sculptures.
